(19) United States
(12) Patent Application Publication
(10) Pub. No.: US 2003/0062841 A1
(43) Pub. Date: Apr. 3, 2003

(54) Method of operating a dimmable fluorescent light

(76) Inventor: Thor Norling, Porsgrunn (NO)

Correspondence Address: Philip G. Meyers Law Office, Suite 302, 1009 Long Prairie Road, Flower Mound, TX, 75022, US

(21) Appl. No.: 10/231,495

(22) Filed: Aug. 30, 2002

Related U.S. Application Data
(60) Provisional application No. 60/316,406, filed on Aug. 31, 2001.

(51) Int. Cl. H05B 37/02

(52) U.S. Cl. 315/149; 315/159

(57) ABSTRACT

A controller for an electronic dimmable ballast is operated in a manner effective to maintain the fluorescent light at less than maximum illumination at all times. It has been found that this reduces energy consumption while extending bulb life. Accordingly, for this purpose the controller is programmed with an upper output voltage limit that corresponds to the desired maximum illumination.

This application claims priority of U.S. Provisional Patent Application Serial No. 60/316,406, filed Aug. 31, 2001.

### TECHNICAL FIELD

The invention relates to fluorescent lighting, particularly a control systems and methods for selective dimming of fluorescent lights in order to conserve energy and extend bulb life.

### BACKGROUND OF THE INVENTION

Fluorescent lights are in widespread use especially for indoor and outdoor commercial lighting. In general, these lights are run at full intensity illumination for extended periods of time, resulting in enormous energy consumption in both commercial and government buildings. Electronically dimmable fluorescent lights have been developed wherein the bulb illumination can be varied, such as the Quicktronic Dimmable control system made by Osram. It has been suggested to dim fluorescent lighting during nighttime hours in order to save energy. However, many businesses have indoor or outdoor lighting that must remain on 24 hours a day, and thus night time dimming may be impractical. For example, businesses such as service stations, convenience stores and the like often maintain lighting systems for gasoline pumps from a large overhead canopy mounted on pillars. For this purpose, individual lights may be mounted on the underside of the canopy to illuminate the area below and are most needed at night. The present invention provides a system for reducing energy consumption by commercial lighting systems without requiring loss of illumination during night time hours.

### SUMMARY OF THE INVENTION

A fluorescent light control system according to the invention includes a light sensor positioned to monitor outdoor illumination proximate an area illuminated by a dimmable fluorescent light, which area receives illumination from the sun during daytime hours, and a controller connected to receive a signal from the sensor indicating the level of outdoor illumination. The controller outputs a control signal to the dimmable fluorescent light which dims or brightens the fluorescent light in order to maintain a predetermined level of illumination, such as a substantially constant illumination, in the illuminated area. The controller may be in the form of a chip providing with a transformer for supplying power to a low voltage side of the chip, so the chip can output a control voltage ranging from 1 to 10 volts to the light fitting for directly controlling the level of illumination.

A corresponding method of controlling a dimmable fluorescent light (or lights) includes the steps of monitoring with a sensor outdoor illumination proximate an area illuminated by a dimmable fluorescent light, which area receives illumination from the sun during daytime hours, and operating a controller connected to receive a signal from the sensor indicating the level of outdoor illumination, which controller dims or brightens the fluorescent light in order to maintain a predetermined illumination in the illuminated area. The area illuminated by a fluorescent light may be an indoor room having a window through which illumination from the sun is received, in which case the sensor is mounted in a position to monitor such illumination, or may be an outdoor area such as a gas station or convenience store canopy.

According to another aspect of the invention, the controller is operated in a manner effective to maintain the fluorescent light at less than maximum illumination at all times. It has been found that this reduces energy consumption while extending bulb life. Accordingly, for this purpose the controller is programmed with an upper output voltage limit that corresponds to the desired maximum illumination, as described further below.

### BRIEF DESCRIPTION OF THE DRAWINGS

In the accompanying drawings, wherein like numerals represent like elements:

FIG. 1 is a schematic diagram of an installation according to the invention;

FIG. 2 is a schematic diagram of the control system shown in FIG. 1;

FIG. 3 is a plot of light frequency versus time over a typical cycle according to the method of the invention; and

FIG. 4 is a plot of power efficiency versus temperature in degrees F. for a typical electronic dimmable fluorescent light used in the invention, wherein 100% efficiency (where the curve peaks) refers to the maximum obtainable, not to absolute efficiency.

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and are not to limit the scope of the invention.

### DETAILED DESCRIPTION

The present invention further provides a dimming system for fluorescent lighting that responds to changes in external illumination. A controller chip according to the invention can be retrofitted to a conventional electronic dimming ballast for fluorescent lighting. Conventional dimmer systems typically decrease illumination in night time hours in order to conserve energy. The present invention takes a different approach.

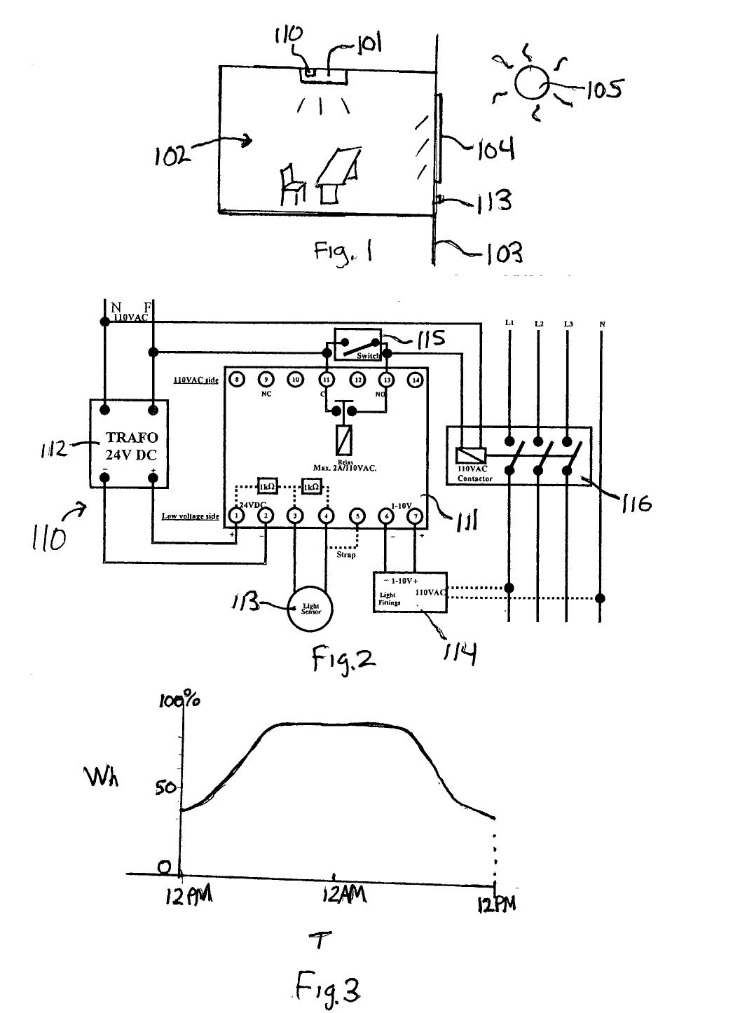

Referring to FIGS. 1 and 2, a lighting system 100 according to the invention includes one or more electronically dimmable fluorescent lights 101 for illuminating a room 102 in a building 103 having an exterior window 104. Ambient light entering room 102 through window 104 will vary the amount of light needed from fluorescent lights 101 to maintain the desired level of light. For this purpose, fluorescent lights 101 are retrofitted with a control system 110 according to the invention. Control system 110 includes a 12-terminal chip 111, a 24V DC transformer 112, a light sensor 113, a light fitting 114, a switch 115 and a 110 V AC contactor 116, connected as shown. Terminals 1-7 are arranged on a low voltage side of chip 111, and terminals 8-14 are on the 100 V AC side. In this example, light sensor 113 is installed, indoors or preferably on an exterior surface of the building, to best gather in the ambient light. Terminals 1 and 2 of chip 111 to +24 Volt DC and −24 V DC respectively on transformer 112, which is in turn connected to a 100 V AC power supply. Terminals 3 and 4 are connected to the sensor 113. Terminals 11 and 13 are connected to switch 115 and to a 2 A/110 V AC relay 116 as shown. Output to the light fitting from terminals 6 and 7 ranges from 1 to 10 volts DC, which is used to vary the illumination proportionately in electronically dimmable fluorescent lights 101. For best efficiency and to maintain the light at 90% or less of maximum illumination at all times, this output is set so that it cannot exceed a predetermined upper limit that corresponds to the desired maximum illumination, preferably around 8.5 V.

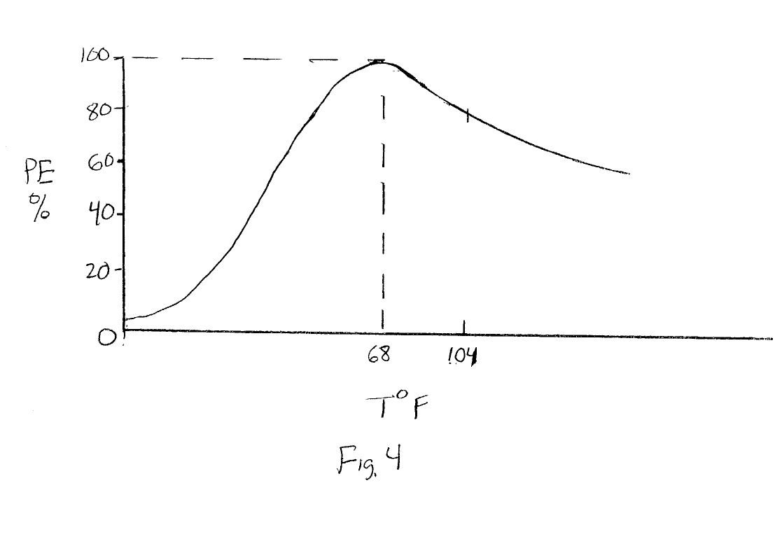

More specifically, it has been found according to the invention that there is a relationship between power efficiency and internal bulb temperature for fluorescent lighting that is a curve that builds to a maximum at a certain temperature determined by the bulb's electrical characteristics and then declines as the temperature increases further, as shown in FIG. 4. In one example, with the controller operating at its maximum of 10 V, the bulb operating temperature is over 100 degrees F. Decreasing this to about 68° F. results in much greater power efficiency, which is the amount of illumination per unit energy consumed. In practice, this corresponds to a value of around 8.5 V on the controller, although the optimum value will vary depending on both the bulb's electrical characteristics and the temperature of the surrounding air, i.e., ambient temperature, as well as the insulating properties of the light enclosure. The maximum may range as high as about 9 to 9.8 V, or as low as 7 to 8 V. If the fluorescent light bulb is in a cold environment (constantly lower than 22° F.), the maximum voltage for the controller will be higher, up to 9 with 4 bulbs×55W, 9.8V with 2 bulbs×55W, whereas in a warmer environment, it will be lower.

There is a slight decrease in illumination changing the internal bulb moving from 100° F. to 68° F., but the decrease in illumination is so small that it can barely be discerned by the eye. The difference in energy consumption, however, is large, as much as 30%. Most of the additional energy supplied to the bulb at the higher voltage setting (10 V) is wasted as heat. In a broad aspect, the present invention applies to any dimmable fluorescent bulb that is constrained to operate at or near (e.g., within about 5° F.) of its maximum power efficiency as defined above, whether or not controlled according to a daily cycle or used with a sensor. This will generally correspond to a level from 80 to 90% of the bulb's normal maximum illumination (its output when undimmed).

Controller 103 receives an input from sensor 100 indicative of illumination in lux (lumen/m²) and translates this to an output voltage using a function or ROM data lookup table, which may be standardized, or is preferably derived by experimentation in which a given change in illumination produces a corresponding desired output. It is necessary for this purpose to translate changes in lux to corresponding changes in voltage on a linear scale as needed to produce a smooth gradual change in illumination. It is preferred according to the invention to poll sensor 113 over a short time interval, every few seconds or even once per second, and to vary the output to the dimmer of the fluorescent light fixture accordingly. Thus, the present invention also compensates for temporary changes in illumination, such as a cloud passing over the sun in the daytime.

Referring to FIG. 3, it is preferred according to the invention to operate the fluorescent lights 101 at about 90% or less of maximum illumination at all times. Frequency controls bulb temperature and maintaining a lower bulb temperature on average extends bulb life with little noticeable loss of illumination. During night hours, when the lights are in use, controller 103 maintains illumination at or near the predetermined maximum, which may range from 50%-90%. As the level of daylight increases during morning hours, lights 101 are gradually dimmed to a minimum level occurring in mid-day, then gradually brightened over the evening hours. Thus, the method of this embodiment strives to save energy by dimming during the day when light from the outdoors is greatest, as opposed to known prior approaches to energy saving, which have focused on dimming fluorescent lights during the evening or otherwise when not in use. The present invention takes the opposite approach and actually increases fluorescent light brightness in the evening hours, when such lighting is most needed. The end result is reduced power consumption and cost, and an increase in useful life of the fluorescent light bulbs.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims. For example, each controller may be pre-programmed for two or more different environments, e.g., indoor and outdoor, and the terminal connections varied at installation to select the desired environment.

1. A method of operating a dimmable fluorescent light, comprising:
varying the brightness of the fluorescent light according to a programmed pattern by means of an automated controller; and
setting the controller to operate the fluorescent light within a brightness range having a predetermined upper limit that is less than maximum illumination.

2. The method of claim 1, wherein the internal bulb temperature is within about 5° F. of a temperature at which the light is operating at maximum power efficiency.

3. The method of claim 1, wherein the light does not exceed 90% of its maximum illumination.
